(19) United States
(12) Patent Application Publication
(10) Pub. No.: US 2025/0187870 A1
(43) Pub. Date: Jun. 12, 2025

(54) ADAPTER FOR CONNECTING AN ELEVATOR CONTROLLER TO A VARIETY OF DATA PROCESSING DEVICES

(71) Applicant: Inventio AG, Hergiswil (CH)

(72) Inventors: Frederic Lee Swern, Florham Park, NJ (US); Howard Plonchak, Teaneck, NJ (US); James Sokolowsky, Warren, NJ (US)

(21) Appl. No.: 18/843,757

(22) PCT Filed: Mar. 2, 2023
(86) PCT No.: PCT/EP2023/055252

§ 371 Date: Sep. 4, 2024

(30) Foreign Application Priority Data
Mar. 11, 2022 (EP) 22161535.4

(51) Int. Cl. B66B 1/34; B66B 5/00

(52) U.S. Cl. CPC B66B 1/3461; B66B 5/0025

(57) ABSTRACT

An adapter for connecting an elevator controller to a variety of data processing devices includes a first remote side data interface unit configured for establishing a data connection to a first data processing device, a second remote side data interface unit configured for establishing a data connection to a second data processing device, a controller side data interface unit configured for establishing a data connection to the elevator controller, and a data transmission selector configured for selectively establishing a data transmission connection between the controller side data interface unit and one of the first and second remote side data interface units. The data transmission selector automatically selects the data transmission taking into account a signal which is signalized at the first remote side data interface unit.

### FIELD

The present invention relates to an adapter for connecting an elevator controller to a variety of data processing devices and to an elevator arrangement comprising such adapter.

### BACKGROUND

In an elevator arrangement, an operation of an elevator is controlled by a controller. For example, the controller may control a drive arrangement for selectively displacing an elevator car along an elevator shaft. Furthermore, the controller may control elevator door arrangements for selectively opening and closing doors in order to thereby enable or block an access to the elevator car. Additionally, the controller may control elevator brakes for selectively decelerating or stopping a motion of the elevator car. A variety of further functions may be implemented in the control.

Upon initial installation and/or subsequent maintenance of the elevator arrangement, an access to the controller may be required for initially setting and/or maintaining an operation of the elevator controller. In such procedure, data may have to be transferred between a maintenance tool and the controller. Using such data exchange, information about current settings in the controller may be downloaded to the maintenance tool and may then be analysed analyzed. Additionally or alternatively, new data may be uploaded from the maintenance tool to the controller for updating settings of the controller.

During normal operation of the elevator arrangement, the operation of the elevator controller may have to be monitored using a remote monitoring device which may e.g. be arranged at a remote monitoring center distant to a building in which the elevator arrangement is located. For example, it may be monitored whether the controller executes its functions correctly or whether any malfunctions or error messages are observable such that counter measures may have to be initiated. For such monitoring, data may have to be transferred between the remote monitoring device and the controller.

Furthermore, an elevator arrangement may be provided or may be retrofitted with an external controlling device. Such external controlling device may serve for implementing additional functions in the elevator arrangement. For example, the external controlling device may be used for implementing a remote car call system via which the elevator arrangement may be instructed to move its elevator car to intended locations. For such purposes, the external controlling device may have to exchange data with the elevator controller.

### SUMMARY

Accordingly, there may be a need for providing an option for connecting the elevator controller to a variety of data processing devices for enabling a data exchange between such data processing devices and the elevator controller. Furthermore, there may be a need for an elevator arrangement in which such data exchange between an internal elevator controller and various data processing devices may be established in a reliable, technically relatively simple and/or cost efficient manner.

Such needs may be met with the subject-matter of the advantageous embodiments defined in the following specification and in the figures.

According to a first aspect of the present invention, an adapter for connecting an elevator controller to a variety of data processing devices is described. The adaptor comprises (i) a first remote side data interface unit configured for establishing a data connection to a first data processing device, (ii) a second remote side data interface unit configured for establishing a data connection to a second data processing device, (iii) a controller side data interface unit configured for establishing a data connection to the elevator controller, and (iv) a data transmission selector configured for selectively establishing a data transmission connection between the controller side data interface unit and one of the first and second remote side data interface units. The data transmission selector is configured for selecting the data transmission taking into account a signal which is signalized at the first remote side data interface.

According to a second aspect of the invention, an elevator arrangement is described, the elevator arrangement comprising an elevator controller for controlling an operation of the elevator arrangement and an adapter according to an embodiment of the first aspect of the invention, the adapter being connected with the elevator controller via its controller side data interface unit.

Ideas underlying embodiments of the present invention may be interpreted as being based, inter alia, on the following observations and recognitions.

Briefly summarized in a non-limiting manner, it has been observed that in many conventional elevator arrangements, the elevator controller comprises only a single data interface via which remote data processing devices may exchange data with the elevator controller. Such data interface was conventionally used during maintenance procedures for downloading and uploading elevator controller setting data.

For example upon modernizing such conventional elevator arrangements, it may be intended to implement some remote monitoring of an operation of the elevator controller. In cases where there is only a single data interface at the elevator controller, such remote monitoring has to be established using this data interface.

However, during a maintenance procedure, a connection of a remote monitoring device to the data interface generally has to be released temporarily such that a maintenance tool may be connected to the elevator controller via the data interface. Accordingly, during such maintenance procedure, no remote monitoring is available. Furthermore, there may be a risk that a technician, after having completed the maintenance procedure, does not correctly reconnect the remote monitoring device to the data interface such that any remote monitoring remains interrupted. For example, a technician having forgotten to reconnect the remote monitoring device may then have to visit the elevator arrangement once more for establishing the required connection to the remote monitoring device.

Furthermore, in cases where there is only a single data interface at the elevator controller, no two different data processing devices may be connected to the elevator controller simultaneously. Accordingly, for example no external controlling device may be used for exchanging data with the elevator controller for implementing additional functionalities in the elevator arrangement while at the same time establishing remote monitoring of the elevator arrangement.

The adapter described herein enables automatically establishing a data connection between the elevator controller having a single data interface only, on the one side, and a variety of data processing devices, on the other side. Therein, a data transmission selector may automatically and selectively establish a data transmission connection between a controller side data interface unit and one of a plurality of remote side data interface units. For such automatic establishing of the data transmission connection, the data transmission selector takes into account a signal which is signalized at at least one of the remote side data interface units. Accordingly, by suitably implementing the data transmission selector in the adapter, the adapter may for example enable a data exchange with a remote monitoring device as long as no maintenance tool is connected to the adapter and/or as long as no data are submitted and/or requested by an external controlling device which is also connected to the adapter.

In the following, possible embodiments of the approach proposed herein shall be described in more detail.

The adapter proposed herein shall have at least three, preferably at least four, data interfaces. One data interface is configured for establishing a data connection to the elevator controller and is therefore referred to as controller side data interface unit. Two or more data interfaces are configured for establishing a data connection to data processing devices which may be remotely connected to the adapter and which therefore are referred to herein as remote side data interface units.

Therein, each data interface unit may be specifically configured for enabling a mechanical and/or an electrical connection to an associated interface provided at the respective other device, i.e. at the elevator controller or the data processing device, respectively. For such purpose, the data interface unit may have mechanical connection means and electrical connection means. For example, the data interface units may be configured as a plug or as a socket, thereby forming a connector which may be connected to a counter-connector at the interface provided at the respective other device.

The data transmission selector in the adapter is configured for selectively establishing a data transmission connection, i.e. for selectively enabling data transmission, between the controller side data interface unit and one, preferably exactly only one, of the remote side data interface units. The data transmission connection may be established automatically by the data transmission selector. Accordingly, no action has to be taken by any human technician for correctly establishing a data transmission between a data processing device connected to one of the remote side data interface units of the adapter, on the one hand, and the elevator controller connected to the controller side data interface unit of the adapter, on the other hand. For controlling the selection of the data transmission connection to be established, the data transmission selector uses a signal which is signalized at the first remote side data interface. Such signal may be signalized automatically upon the first data processing device being connected to the first remote side data interface.

According to an embodiment, the first remote side data interface unit is configured for establishing a data connection to a maintenance tool. I.e., in this case, the first data processing device is a maintenance tool. Such maintenance tool is configured for, upon being connected to the first remote side data interface unit and the data transmission connection being established between the controller side data interface unit and the first remote side data interface unit, exchanging data via the adapter from and/or to the elevator controller being connected to the controller side data interface unit. Therein, the data exchange between the maintenance tool and the elevator controller is specifically configured for maintaining an operation of the elevator controller. For example, the maintenance tool may submit data to the elevator controller for updating settings in the elevator controller. Alternatively or additionally, the maintenance tool may receive data from the elevator controller and analyze such data for obtaining information about a current operation status of the elevator controller. Such data exchange may be specifically adapted for fulfilling maintenance requirements. The maintenance tool typically is a non-stationary device, i.e. a portable device.

According to an embodiment, the second remote side data interface unit is configured for establishing a data connection to a remote monitoring device, i.e., in this case, the second data processing device is a remote monitoring device. Such monitoring device is configured for, upon being connected to the second remote side data interface unit and the data transmission connection being established between the controller side data interface unit and the second remote side data interface unit, exchanging data via the adapter from and/or to the elevator controller being connected to the controller side data interface unit. Therein, the data exchange between the remote monitoring device and the elevator controller is specifically configured for remotely monitoring an operation of the elevator controller. For example, the remote monitoring device may receive data from the elevator controller and analyze such data for obtaining information about a current operation of the elevator controller, such information enabling for example detecting any malfunctions in the elevator arrangement. Typically, the remote monitoring device is a stationary device being fixedly installed e.g. at a remote monitoring center located outside the building which accommodates the elevator arrangement.

According to an embodiment, the data transmission selector is configured for establishing the data transmission connection between the controller side data interface unit and the first remote side data interface unit upon detecting that the first data processing device is connected to the first remote side data interface unit. Therein, the data transmission selector may detect that the first data processing device is mechanically connected and/or electrically connected to the first remote side data interface unit. Upon such detection, a signal may be generated. For example, the signal may be generated by the first data processing device and may be submitted to the adapter via the first remote side data interface unit such that the data transmission selector may receive such signal. Alternatively or additionally, the adapter itself may have provisions for generating such signal. For example, the adapter may comprise a sensor or a switch which is activated upon the first data processing device being connected to the first remote side data interface unit and which, upon such activation, emits the required signal.

Accordingly, when a maintenance tool is connected to the first remote side data interface unit, while at the same time a remote monitoring device is connected to the second remote side data interface unit, the data transmission selector may detect such maintenance tool being newly connected to the adapter and may then automatically establish a data transmission connection between the controller side data interface unit and the first remote side data interface unit for enabling data transmission between the maintenance tool and the elevator controller. Therein, such data transmission shall be preferably be prioritized, i.e. even though the remote monitoring device was already connected to the adapter prior to the maintenance tool, a data transmission connection being previously established between the controller side data interface unit and the second remote side data interface unit, i.e. with the remote monitoring device, will be automatically interrupted by the data transmission selector and is replaced by establishing a data transmission connection between the controller side data interface unit and the first remote side data interface units, i.e. with the newly connected maintenance tool.

As soon as the maintenance tool is disconnected from the adapter, this may preferably also be detected by the data transmission selector. As a reaction, the data transmission selector may then automatically re-establish the previous data transmission connection between the controller side data interface unit and the second remote side data interface unit, thereby automatically again enabling data transmission between the remote monitoring device and the elevator controller.

According to an embodiment, the adapter further comprises a third remote side data interface unit configured for establishing a data connection to a third data processing device. Therein, the data transmission selector is configured for selectively establishing a data transmission connection between the controller side data interface unit and one of the first, second and third remote side data interface units. The data transmission selector is configured for selecting the data transmission taking into account a signal which is signalized at at least one of the first remote side data interface and the third remote side data interface.

In other words, the adapter may comprise at least three remote side data interfaces for connecting three different data processing devices to the elevator controller. The data transmission selector is then configured for automatically establishing a data transmission connection between the controller side data interface unit and one, preferably exactly only one, of the remote side data interface units. Upon such selection, the data transmission selector may preferably take into account at least one signal which is signalized at the first or the third remote side data interface. Preferably, a first signal is generated and received at the first remote side data interface unit upon and/or while the first data processing device is connected thereto and, additionally, a second signal is generated and received at the third remote side data interface unit upon and/or while the third data processing device is connected thereto. Preferably, the data transmission selector takes into account both, the first and the second signals, upon determining which data transmission connection is to be automatically established.

According to an embodiment, the third remote side data interface unit is configured for establishing a data connection to an external controlling device. In other words, the third data processing device is an external controlling device. Such external controlling device is configured for, upon being connected to the third remote side data interface unit and the data transmission connection being established between the controller side data interface unit and the third remote side data interface unit, exchanging data via the adapter from and/or to the elevator controller being connected to the controller side data interface unit. Therein, the data exchange between the external controlling device and the elevator controller is specifically configured for controlling the operation of the elevator controller in accordance with functionalities implemented in or controlled by the external controlling device. For example, the external controlling device may receive data from the elevator controller and may analyze such data for obtaining information about a current operation of the elevator controller. Such information may then be used in the external controlling device upon controlling additional elevator functionalities. In order to implement such additional elevator functionalities, the external controlling device may then transmit data to the elevator controller for suitably controlling the operation of the elevator controller. Typically, the external controlling device is a stationary device, i.e. non-portable but fixedly installed e.g. at or near the elevator controller or, alternatively, at a remote position.

According to an embodiment, the data transmission selector is configured for establishing the data transmission connection between the controller side data interface unit and the third remote side data interface unit upon detecting that signals are received via the third remote side data interface unit while the first data processing device not being connected to the first remote side data interface unit.

In other words, the data transmission selector may automatically detect whether or not signals are received at the third remote side data interface. Such signals may be transmitted for example by the third data processing device, i.e. for example by the external controlling device. Furthermore, the data transmission selector may automatically detect whether the first data processing device, i.e. for example a maintenance tool, is electrically and/or mechanically connected to the first remote side data interface unit. Upon detecting that signals are received at the third remote side data interface unit but no data processing device is connected to the first remote side data interface unit, the data transmission selector may then automatically establish a data transmission connection between the controller side data interface unit, i.e. between the elevator controller, on the one hand and the third remote side data interface unit, i.e. the external controlling device, on the other hand. Such data transmission connection shall be prioritized in relation to a data transmission connection which has been previously established between the elevator controller and a remote monitoring device, i.e. between the controller side data interface unit and the second remote side data interface unit.

However, in cases where the data transmission selector detects that a maintenance tool used as a first data processing device is connected to the first remote side data interface unit, a data transmission connection between the elevator controller and such maintenance tool shall be established with highest priority. This means that even when a data transmission connection has previously been established between the elevator controller and the external controlling device, such data transmission connection shall be temporarily interrupted and replaced by a data transmission connection between the elevator controller and the maintenance tool as soon and/or as long as the maintenance tool is connected to the adapter.

According to an embodiment, the adapter is configured for receiving and transmitting data between at least one of the remote side data interface units and the controller side data interface in accordance with one of the RS-422 standard and the RS-232 standard.

RS-422, also known as TIA/EIA-422, is a technical standard originated by the Electronic Industries Alliance that specifies electrical characteristics of a digital signaling circuit. It offers much higher speed, better immunity from noise and longer cable lengths compared to e.g. the older RS-232C standard. RS-422 systems can transmit data at rates as high as 10 Mbit/s, or may be sent on cables as long as 1,200 meters (3,900 ft) at lower rates. RS-422 specifies differential signaling, with every data line paired with a dedicated return line. It is the voltage difference between these two lines that define the mark and space, rather than, as in RS-232, the difference in voltage between a data line and a local ground. As the ground voltage may differ at either end of the cable, this required RS-232 to use signals with voltage magnitudes greater than 5 volts. Moving to dedicated return lines and always defining ground in reference to the sender allows RS-422 to use 0.4 V, allowing it to run at much higher speeds. Several key advantages offered by this standard include the differential receiver, a differential driver and high data rates.

According to an embodiment, each of the remote side data interface units and the controller side data interface unit comprises a level converter configured for changing each of RS-422 signals and RS-232 signals to a common serial level. The serial level communication may also be referred to as TTL (transistor transistor logic). The serial level signals may then be transmitted from each of the remote side data interface units to the data transmission selector. Upon the data transmission selector having suitably established the data transmission connection between the controller side data interface unit and one of the remote side data interface units, the serial level signals may then be forwarded from the selected one of the remote side data interface units to the elevator controller connected to the controller side data interface unit, and/or vice versa.

It shall be noted that possible features and advantages of embodiments of the invention are described herein partly with respect to an adapter for connecting an elevator controller to a variety of data processing devices and partly with respect to an elevator arrangement in which such adapter is implemented. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows an adapter in an elevator arrangement in accordance with an embodiment of the present invention.

FIG. 2 show details of an adapter in accordance with an embodiment of the present invention.

The figures are only schematic and not to scale. Same reference signs refer to same or similar features.

### DETAILED DESCRIPTION

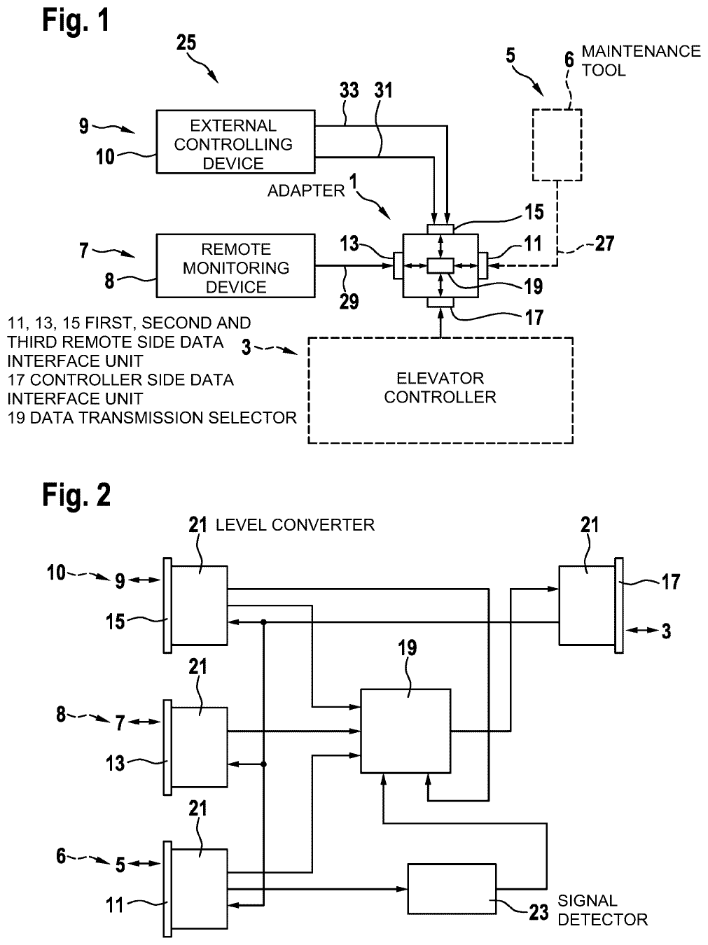

FIG. 1 shows an adapter 1 for connecting an elevator controller 3 to a variety of data processing device 5, 7, 9. Therein, a first data processing device 5 is formed by a maintenance tool 6, a second data processing device 7 is formed by a remote monitoring device 8 and a third data processing device 9 is formed by an external controlling device 10. A first remote side data interface unit 11 is configured for establishing a data connection to the first data processing device 5. A second remote side data interface unit 13 is configured for establishing a data connection to the second data processing device 7. A third remote side data interface unit 15 is configured for establishing a data connection to the third data processing device 9. A controller side data interface unit 17 is configured for establishing a data connection to the elevator controller 3.

The adapter 1 comprises a data transmission selector 19 which may selectively and automatically establish a data transmission connection between the controller side data interface unit 17 and one of the remote side data interface units 11, 13, 15. Therein, the data transmission selector 19 is configured for specifically selecting the data transmission to be established taking into account a signal which is signalized at the first remote side data interface unit 11 and, optionally, furthermore taking into account a signal which is signalized at the third remote side data interface unit 15.

In conventional elevator arrangements, an elevator controller 3 typically has a single serial hardware connector at the controller for a service technician to connect a special maintenance tool 6 to obtain information needed to perform maintenance. The same serial connection point provided by the single serial hardware connector may need to be used for implementing other functionalities such as e.g. remote monitoring and/or external control applications to perform functions associated with elevator monitoring and elevator control.

For example, a remote monitoring connection to the elevator controller 3 may be established during normal operation of the elevator arrangement by connecting a remote monitoring device 8 directly to a data interface provided at the elevator controller 3. During a maintenance procedure, such connection of the remote monitoring device 8 is generally simply removed by a service technician to connect a specific maintenance tool 6 to the data interface provided at the elevator controller 3 in order to thereby e.g. diagnose an elevator problem. Other solutions in use include a box containing a rotary switch to manually switching between the special maintenance tool and remote monitoring.

Embodiments of the adapter 1 presented herein allow two or three remote side data interface units formed for example by hardware connectors to an RS-422 serial connection to share this connection with minimal—or no—modification of the hardware or software of the connecting devices. Further, the adapter may be used on any controller, i.e. independent of its manufacturer, as long as the controller 3 interfaces its maintenance tool 6 via a predefined connection such as an RS-422 connection.

According to an exemplary embodiment, the adapter 1 comprises an adapter board mounted in the controller cabinet and connected to its first remote side data interface unit 5 formed e.g. by an RS-422 maintenance tool connector. If an existing cable normally used to connect remotely to the maintenance tool 6 is connected at the time of adapter board installation, it may be connected to this adapter board using an RS-422 connection 27. The remote connection will function as if the cable were directly connected to the controller side data interface unit 17 forming the maintenance tool connector. Embodiments of the adapter 1 may also contain separate serial connections for remote monitoring and external control utilizing the second and third remote side data interface units 13, 15 formed e.g. by specific connectors on the adapter board. For example, the remote monitoring device 8 is connected to the second remote side data interface unit 13 via an RS-232 connection 29 and the external control device 10 is connected to the third remote side data interface unit 15 via an RS-422 connection 31 or an RS-232 connection. Furthermore, the external control device 10 is connected to the third remote side data interface unit 15 via a control line 33.

When the maintenance tool 6 is not plugged in to the adapter 1 and the external control device 10 is not asserting that it needs the interface, the remote monitoring device 8 may access the controller 3 to perform its functions. If the external control device 10 asserts its control signal, the interface to the remote monitoring device 8 will be disabled and the external control application will have control of the serial connection. When the maintenance tool 6 is plugged in, it will gain access to the controller 3 and it will appear to the service technician that the maintenance tool 6 is working as if the other users of the serial interface provided by the adapter 1 are not present.

As shown in FIG. 1, the serial adapter 1 may be mounted on or near the controller side data interface unit 17 forming a maintenance tool connector in an elevator controller cabinet of an elevator arrangement 25.

FIG. 2 shows a schematic view of a circuitry in an embodiment of the adapter 1. At each of the first, second and third remote side data interface units 11, 13, 15, a level converter 21 is provided. The level converters 21 change each of the RS-422 or RS-232 signals submitted from one of the first, second and third data processing devices 5, 7, 9 to a common serial level such as TTL. A data output from the controller 3 received at the controller side data interface unit 17 is also changed by a level converter 21 and is then fanned out to the maintenance tool 6, the remote monitoring device 8 and the external control device 10 via the respective first, second and third remote side data interface units 11, 13, 15.

In this embodiment, the input to the controller 3 is selected by the data transmission selector 19, which may be formed e.g. by an electrical switch and which is driven e.g. by two discrete signals: (i) a signal via the RS-422 connection 31 from the external control device 10 which is nominally RTS but may be any other available discrete signal, and (ii) a signal detector 23 that indicates whether the maintenance tool 6 is plugged in or not and generates an internal discrete signal.

One of the many possible forms of operation of the data transmission selector 19 is as follows:

| Maintenance Tool | | |
|---|---|---|
| Inserted | External Control Discrete | Serial Input Selected |
| No | Yes | External Control Device |
| No | No | Remote Monitoring |
| | | Device |
| Yes | Yes | Maintenance Tool |
| Yes | No | Maintenance Tool |

An integral part of embodiments of the invention is the RS-422 signal detection mechanism that operates in the following manner. Good design of an RS-422 network dictates that bias resistors be added to each side of the RS-422 line to either voltage or ground to prevent the state of the RS-422 line becoming indeterminate when all transmitters are off. Normally, the “B” or noninverting (+) side is connected to positive voltage and the “A” or inverting (−) side is connected to ground resulting in the receiver indicating a “mark” or off state. In this embodiment of the invention, the “A” or inverting (−) side is connected to positive voltage while the “B” or noninverting (+) side is connected to ground indicating a “space” or on state.

When a maintenance tool 6 with an active RS-422 driver is connected to the adapter 1, the state quickly changes from “space” to “mark” which is easily detected and stays in this state until the maintenance tool 6 sends over some data. To prevent the detecting circuit from switching when the line changes on character transmission, the detecting circuit must see a changed state for a significant fraction of a second before declaring that the maintenance tool 6 has been inserted or removed. This delay will not be noticed by the user.

The above is a non-limiting description of embodiments of this invention. Other embodiments may employ configuration logic that detects switching to any of the inputs (external control device, remote monitoring device, monitoring tool) based on either detection of the RS-422 signal when that input is connected or a discrete switching signal for an input that is always connected. Yet other embodiments may not employ an external control input at all. Such embodiments would employ the appropriate switching logic to move between inputs.

A possible advantage of embodiments of the invention is that the adapter 1 switches the controller input from the RS-422 cable on the special maintenance tool 6 and, optionally, the RS-232 input for remote monitoring whenever the RS-422 input is plugged-in, and switches back when the special maintenance tool 6 is removed. This allows the special maintenance tool 6 to be used by service technicians without regard to the fact that the controller service connection is also being used for remote monitoring. In particular, a cable connection from the controller service connection through the traveling cable to a car operation panel (COP) still functions properly without the service technician going to a machine room to physically disconnect or manually switch the service connection input on the controller from remote monitoring to the special maintenance tool.

Summarizing, when service technicians must disconnect the remote monitoring device 8 and/or, optionally, the external control device 10 in a conventional elevator arrangement to service the elevator arrangement, they are likely to forget to reconnect the remote monitoring device 8 and/or the external control device 10 when they complete their service. In the case of remote monitoring, this may not be detected immediately and require another trip back to the facility to correct. With the adapter 1 as described herein being installed at the elevator controller 3, no temporary disconnecting of other devices is required any more during a maintenance procedure. Instead, the adapter 1 always automatically establishes the suitable data connection to each of various data processing devices 5, 7, 9 based on detecting the presence and/or signal provision of the maintenance tool 6, the remote monitoring device 8 and/or the external control device 10. Thus, continued remote monitoring after completion of the maintenance procedure may be automatically enabled.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. An adapter for connecting an elevator controller to a variety of data processing devices, the adaptor comprising:
a first remote side data interface unit configured to establish a data connection to a first data processing device;
a second remote side data interface unit configured to establish a data connection to a second data processing device;
a controller side data interface unit configured to establish a data connection to the elevator controller;
a data transmission selector configured to selectively establish a data transmission connection between the controller side data interface unit and one of the first and second remote side data interface units; and
wherein the data transmission selector is configured to select the data transmission connection based on a signal that is signalized at the first remote side data interface unit.

14. The adapter according to claim 13 wherein the first remote side data interface unit is configured to establish the data connection to a maintenance tool being the first data processing device, and when the maintenance tool is connected to the first remote side data interface unit and the data transmission connection is established between the controller side data interface unit and the first remote side data interface unit, the maintenance tool exchanges data via the adapter from and/or to the elevator controller being connected to the controller side data interface unit for maintaining an operation of the elevator controller.

15. The adapter according to claim 13 wherein the second remote side data interface unit is configured to establish the data connection to a remote monitoring device being the second data processing device, and when the remote monitoring device is connected to the second remote side data interface unit and the data transmission connection is established between the controller side data interface unit and the second remote side data interface unit, the remote monitoring device exchanges data via the adapter from and/or to the elevator controller being connected to the controller side data interface unit for monitoring an operation of the elevator controller.

16. The adapter according to claim 13 wherein the data transmission selector establishes the data transmission connection between the controller side data interface unit and the first remote side data interface unit upon detecting that the first data processing device is connected to the first remote side data interface unit.

17. The adapter according to claim 13 including a third remote side data interface unit configured to establish a data connection to a third data processing device, wherein the data transmission selector selectively establishes the data transmission connection between the controller side data interface unit and one of the first, second and third remote side data interface units, and wherein the data transmission selector selects the data transmission connection based upon at least one of the signal that is signalized at the first remote side data interface unit and a signal that is signalized at the third remote side data interface unit.

18. The adapter according to claim 17 wherein the third remote side data interface unit is configured to establish a data connection to an external controlling device being the third data processing device, the external controlling device being configured for, and when external controlling device is connected to the third remote side data interface unit and the data transmission connection is established between the controller side data interface unit and the third remote side data interface unit, the external controlling device exchanges data via the adapter from and/or to the elevator controller being connected to the controller side data interface unit for controlling an operation of the elevator controller.

19. The adapter according to claim 17 wherein the data transmission selector establishes the data transmission connection between the controller side data interface unit and the third remote side data interface unit upon detecting that signals are received via the third remote side data interface while the first data processing device is not connected to the first remote side data interface unit.

20. The adapter according to claim 17 wherein the adapter receives and transmits data between at least one of the first, second and third remote side data interface units and the controller side data interface unit in accordance with one of the RS-422 standard and the RS-232 standard.

21. The adapter according to claim 17 wherein each of the first, second and third remote side data interface units and the controller side data interface unit includes a level converter that changes each of RS-422 signals and RS-232 signals to common serial level signals.

22. An elevator arrangement comprising:
an elevator controller for controlling an operation of the elevator arrangement; and
the adapter according to claim 17, the adapter being connected with the elevator controller via the controller side data interface unit.

23. An elevator arrangement according to claim 22 including an external controlling device connected to the third remote side data interface unit of the adapter.

24. An elevator arrangement comprising:
an elevator controller for controlling an operation of the elevator arrangement; and
the adapter according to claim 13, the adapter being connected with the elevator controller via the controller side data interface unit.

25. The elevator arrangement according to claim 24 including a remote monitoring device connected to the second remote side data interface unit of the adapter.
